(19) United States
(12) Patent Application Publication
(10) Pub. No.: US 2014/0000859 A1
(43) Pub. Date: Jan. 2, 2014

(54) VARIABLE-SPEED PUMP CONTROL FOR COMBUSTION ENGINE COOLANT SYSTEM

(71) Applicant: Osama A. Abihana, Dearborn, MI (US)

(72) Inventor: Osama A. Abihana, Dearborn, MI (US)

(73) Assignee: FORD GLOBAL TECHNOLOGIES, LLC, DEARBORN, MI (US)

(21) Appl. No.: 13/534,401

(22) Filed: Jun. 27, 2012

(51) Int. Cl. B60H 1/00; F01P 7/14; F28F 27/02

(52) U.S. Cl. 165/202; 165/244; 123/568.12

(57) ABSTRACT

A cooling system for an internal combustion engine in a vehicle comprises a variable-speed coolant pump and a plurality of heat-transfer nodes coupled in a coolant loop with the pump. Each node generates a flow rate request based on an operating state of the node. A pump controller receives the flow rate requests, maps each respective flow request to a total pump flow rate that would produce the respective pump flow rate request, selects a largest mapped pump flow rate, and commands operation of the pump to produce the selected flow rate.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to controlling a variable speed pump for a coolant system of an internal combustion engine, and, more specifically, to minimizing energy consumption for operating the pump while maintaining a minimum required flow for each component or node connected in the coolant loop.

Because of their high operating temperatures, internal combustion engines require the use of a cooling system to dissipate heat through a radiator in order to maintain the engine at an optimum temperature. Requirements for the coolant system include rapid warming of a cold engine, removing excess heat from the engine, and supplying heat to components that use the heat such as a heater core for cabin warming, or a heat recovery device of a type that may generate electricity (e.g., exhaust based or manifold based) or that cools exhaust gases for an exhaust gas return (EGR) valve.

A coolant pump (often called the water pump) has traditionally been mechanically driven from the output of the internal combustion engine. The pump has been conventionally sized to give a pumping capacity (i.e., flow rate) sufficient to meet maximum requirements.

Electric pumps have begun to replace mechanically-driven in order to lower the load on the engine at times when no flow or low flow is needed in the coolant loop. Electric pumps are also used on hybrid gas-electric vehicles for the additional reason that a coolant flow may be needed during times that the vehicle is operating off of the battery and the internal combustion engine is inactive (e.g., to provide cabin heating via an electric heater coupled to the cooling system or to cool electric vehicle's battery or fuel cell).

An electric pump can be operated at a variable speed in order to lower its energy consumption during times that the need for coolant flow is lower. However, prior coolant systems for modulating flow have been complex and expensive (e.g., by requiring additional flow control valves, sensors, and complex control strategies). It would be desirable to reduce power consumption of an electric water heater while maintaining adequate flow for all components in a simple and efficient manner.

### SUMMARY OF THE INVENTION

In one aspect of the invention, vehicle apparatus comprises a variable-speed coolant pump and a plurality of heat-transfer nodes coupled in a coolant loop with the pump. Each node generates a flow rate request based on an operating state of the node. A pump controller receives the flow rate requests, maps each respective flow request to a total pump flow rate that would produce the respective pump flow rate request, selects a largest mapped pump flow rate, and commands operation of the pump to produce the selected flow rate.

### BRIEF DESCRIPTION OF THE DRAWINGS

FIG. 1 is a block diagram showing a coolant loop and associated components for a first embodiment adapted for a gas-electric hybrid vehicle.

FIG. 2 is a block diagram showing a coolant loop and associated components for a second embodiment adapted for another gas-electric hybrid vehicle architecture.

FIG. 3 illustrates a general process of the present invention for determining an optimum flow rate for operating the pump.

FIGS. 4 is a graph showing relationships between total pump output and the resulting flow rate at different nodes in the coolant loop.

FIG. 5 illustrates a derived flow distribution and its use in mapping to a pump flow.

FIG. 6 is a flowchart showing one preferred method of the invention.

### DETAILED DESCRIPTION OF PREFERRED EMBODIMENTS

The main purpose of the electric coolant pump is to deliver necessary coolant flow to meet the heat exchange requirements of all the components (referred to herein as heat-transfer nodes) connected to the cooling system, including the engine, climate components such as a heater core, and heat recovery components such as an EGR cooler. Instead of continuously operating the coolant pump at a flow rate great enough to cover the worse case cooling needs, it would be desirable to maximize fuel economy by minimizing cooling system power consumption. However, no pump control strategy has yet been available that achieves the goal of minimizing the power consumption without potentially under-delivering flow to any components in a simple and efficient manner.

In the present invention, each node requests a coolant flow rate which it determines according to its specific needs at the time of the request (regardless of how the component hardware is connected within the cooling system or how its flow interacts with other components). The flow rate request of each node is mapped (e.g., via a lookup table or formula) to a total pump flow rate that is empirically known to result in a component flow equal to the request. To ensure that all components receive at least their requested flow rate, the present invention arbitrates all the flow requests from the different components and operates the pump accordingly.

An advantage of the invention is that a single approach can be used for the pump control regardless of how the components in the system are connected. All that is required when designing a pump control for a different model of vehicle is to configure the appropriate mapping relationships.

Referring now to FIG. 1, a vehicle apparatus 10 includes an engine 11 which may be an internal combustion engine mounted in a hybrid electric vehicle, for example. A pump 12 supplies pressurized coolant to circulate through engine 11 and various other components via a plurality of coolant lines 13. In addition to engine 11, other heat-transfer nodes include a heater core 15, auxiliary heater 16, and a heat recovery device in the form of an exhaust gas recirculation (EGR) cooler 17. A radiator 20 is coupled in the coolant loop between engine 11 and pump 12 via a thermostat 21. When coolant temperature is below a threshold, thermostat 21 blocks radiator flow so that coolant instead follows a bypass 22. Radiator 20 is coupled to a degas system 23 in a conventional manner.

Each heat-transfer node operates in conjunction with a respective controller. Thus, engine 11 is controlled by an engine control module (ECM) 25. An electronic automatic temperature control (EATC) controller 26 operates a climate control system including heater core 15 and auxiliary heater 16 which is electrically powered to supply passenger cabin heat when engine 11 is off. EGR 17 may be controlled by ECM 25 or by a separate controller.

A pump controller 27 is coupled to pump 12 for commanding a pump operating speed in accordance with a desired pump flow rate as determined in accordance with the present invention. Pump controller 27 is coupled to ECM 25 and EATC 26 in order to receive flow rate requests corresponding to the various heat-transfer nodes. Pump controller 27 arbitrates the various requests and activates pump 12 at the lowest appropriate speed (i.e., at the lowest power consumption) for meeting all the current flow requests.

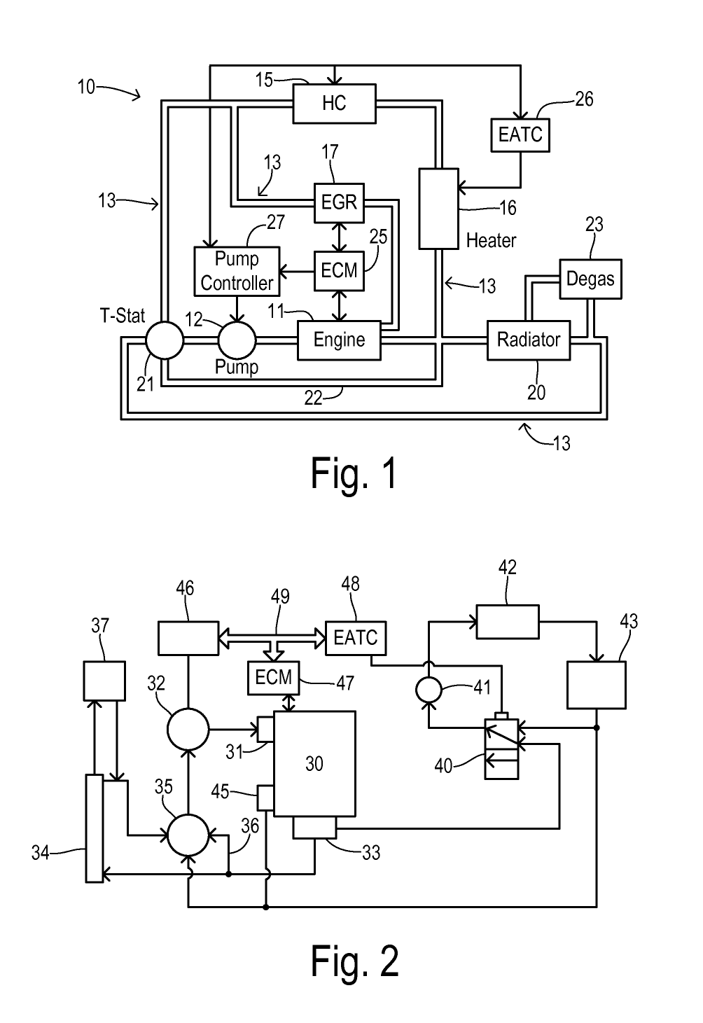

FIG. 1 represents a system corresponding to a full (i.e., standalone) hybrid electric vehicle. A system architecture of the type used for a plug-in hybrid electric vehicle is shown in FIG. 2. An internal combustion engine 30 has a coolant inlet 31 connected to the outlet of a variable speed pump 32. Engine 30 has a coolant outlet 33 connected to a radiator 34 and a thermostat 35 via a bypass 36. Radiator 34 is connected to a degas bottle 37 and has an outlet connected to thermostat 35.

Outlet 33 is also coupled to one inlet of a valve 40. The outlet of valve 40 is connected to the inlet of an auxiliary pump 41 having its outlet connected to a heater core 42. An electric heater 43 is connected in series with heater core 42 and has its outlet coupled in parallel to a second inlet of valve 40 and to thermostat 35. Valve 40 is configurable to provide a flow from engine outlet 33 through heater core 42 during times that engine 30 is operating. When engine 30 is not operating and there is a demand for heat in the passenger cabin, valve 40 is switched to provide flow in an auxiliary loop including auxiliary pump 41, heater core 42, and supplement heater 43.

An EGR 45 receives coolant from engine 30 and then back to an inlet of thermostat 35.

A pump controller 46 is coupled to pump 32. An ECM 47 and an EATC 48 control the engine and climate control systems, respectively, and send corresponding flow rate request messages to pump controller 46 over a multiplex bus 49.

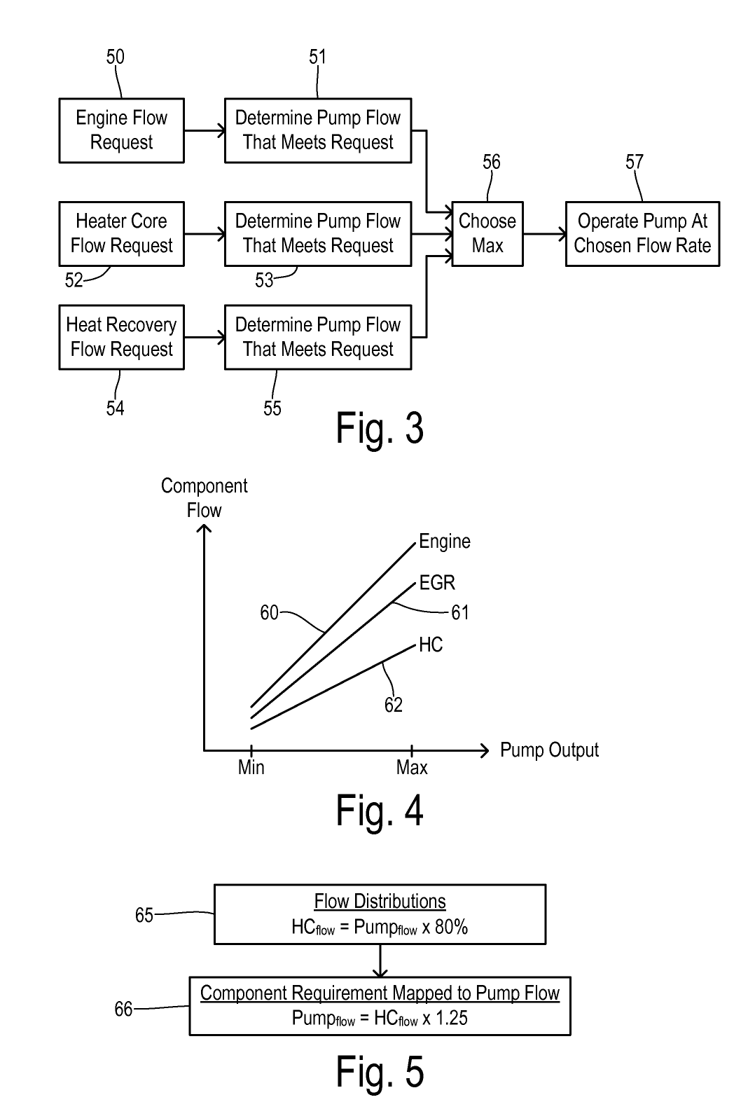

The pump controller performs a flow request arbitration as shown in FIG. 3. In block 50, an engine flow request is received that was generated by the engine control system based on the coolant flow required for the engine to meet its current attributes. In block 51, the pump flow rate necessary to meet the engine flow request is determined. Likewise, a heater core flow request is shown in block 52 and the pump flow rate needed to meet the heater core flow request is determined at block 53. If a heat recovery device is present, then a heat recovery flow request is received at block 54 and the pump controller determines the pump flow meeting that request at block 55. In the event that other heat-transfer nodes having unique needs for receiving coolant are present, then similar flow rate requests would be received and similarly mapped pump flow rates would be determined that meet each respective request. In block 56, the maximum pump flow rate is determined, and in block 57 the pump is operated at the chosen flow rate.

Each unique vehicle design employs a particular layout of the coolant loop which results in a characteristic distribution of the flow from the water pump. The engine may typically receive 100% of the total flow (i.e., is in series between the pump and all other components), but not necessarily so. The typical coolant loop also includes various parallel branches such as one supplying the heater core and one supplying the EGR. The proportional distribution of the total flow between such parallel branches substantially constant as shown in FIG. 4. Component flows are shown for various nodes according to a total pump flow output between a minimum pump output and a maximum pump output. In one hypothetical example, an engine flow 60 is shown which is equal to (i.e., 100% of) the pump output. An EGR flow 61 maintains a flow of about 75% of the pump output, and a heater core flow 62 maintains a flow of about 50% of the pump output.

The characteristic flow distribution for a coolant loop provides a mapping for determining the needed pump flow rate as shown in FIG. 5. In block 65, the flow distributions for the coolant loop are identified, such as a heater core distribution in which the actual heater core flow (HC_{flow}) is equal to the total pump flow (PUMP_{flow}) times 80%. Similar distribution values for the other components are determined by empirical measurement or by simulation, and all the relationship are stored as a mapping table or as formulas for use by the pump controller. the stored relationships are subsequently used by the pump controller for the mapping shown in block 66, wherein a requested component flow requirement (HC_{request}) is multiplied by 1.25 (equivalent to dividing by 80%) to obtain the corresponding pump flow. This value of pump flow is then arbitrated with the values obtained according to the requests from the other components.

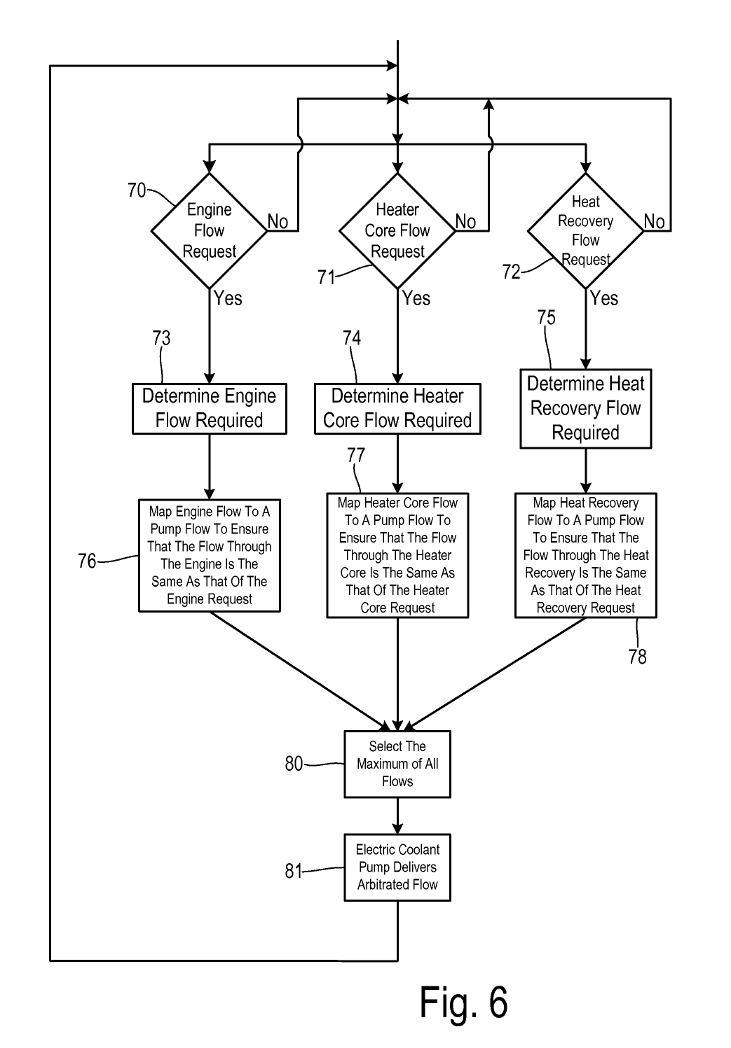

The present invention may be implemented in a manner that periodically updates pump operation based on the most recent requests or may be configured to update pump operation only in response to actual flow requests as shown in FIG. 6. Thus, whenever the internal combustion engine is active, steps 70-72 monitor for incoming flow rate requests from the engine, heater core, or heat recovery device, respectively. When any of the requests are detected, the pump controller determines the flow rate required by the incoming request in steps 73-75 and then maps each required flow rate to the pump flow that ensures a flow the same as that of each respective request in steps 76-78. The maximum of all mapped flows is selected in step 80 and the electric coolant pump then delivers the arbitrated flow in step 81.

What is claimed is:

1. Vehicle apparatus comprising:
a variable-speed coolant pump;
a plurality of heat-transfer nodes coupled in a coolant loop with the pump, wherein each node generates a flow rate request based on an operating state of the node; and
a pump controller receiving the flow rate requests, mapping each respective flow request to a pump flow rate that would produce the respective pump flow rate request, selecting a largest mapped pump flow rate, and commanding operation of the pump to produce the selected flow rate.

2. The vehicle apparatus of claim 1 wherein the plurality of heat-transfer nodes includes an engine node and a cabin heating node.

3. The vehicle apparatus of claim 2 wherein the engine node includes an internal combustion engine and an engine control module.

4. The vehicle apparatus of claim 2 wherein the cabin heating node includes a heater core and an electronic temperature control module.

5. The vehicle apparatus of claim 4 wherein the cabin heating node further includes an electric heater.

6. The vehicle apparatus of claim 2 wherein the plurality of heat-transfer nodes includes a heat recovery node.

7. The vehicle apparatus of claim 6 wherein the heat recovery node includes an exhaust gas recirculation cooler.

8. The vehicle apparatus of claim 1 wherein the variable-speed coolant pump is electrically driven.

9. A method of controlling coolant flow rate provided by a variable-speed coolant pump in a coolant loop in a vehicle, the method comprising the steps of:
sending a flow rate request from each of a plurality of heat-transfer nodes to a pump controller based on an operating state of each respective node;
mapping each respective flow request to a pump flow rate that would produce the respective pump flow rate request;
selecting a largest mapped pump flow rate; and
commanding operation of the pump to produce the selected flow rate.

10. Apparatus comprising:
a coolant pump;
a plurality of nodes coupled in a coolant loop, each node generating a flow rate request based on its operating state; and
a pump controller receiving the flow rate requests, mapping each respective flow request to a pump flow rate that would produce the respective pump flow rate request, selecting a largest mapped pump flow rate, and commanding operation of the pump to produce the selected flow rate.
